(19) United States
(12) Patent Application Publication
(10) Pub. No.: US 2016/0055533 A1
(43) Pub. Date: Feb. 25, 2016

(54) RESPONSE GENERATION DEVICE, RESPONSE GENERATION METHOD, AND NON-TRANSITORY COMPUTER READABLE STORAGE MEDIUM

(71) Applicant: YAHOO JAPAN CORPORATION, Tokyo (JP)

(72) Inventors: Kaori TANIO, Tokyo (JP); Ikuo KITAGISHI, Tokyo (JP)

(21) Appl. No.: 14/822,373

(22) Filed: Aug. 10, 2015

(30) Foreign Application Priority Data
Aug. 20, 2014 (JP) 2014-167793

(51) Int. Cl. G06Q 30/02; G06Q 50/12; G06N 5/04

(52) U.S. Cl. CPC G06Q 30/0257; G06N 5/04; G06Q 50/12

(57) ABSTRACT

A response generation device according to the present invention includes a determination unit and an output control unit. The determination unit determines the trend in progress of user interaction between an interactive agent system and the user. The interactive agent system outputs a response message to an input message. The output control unit controls the output so as to output a response message in accordance with the trend in progress of the user interaction determined by the determination unit. Thus, the response generation device can output a message appropriate for the user.

### CROSS-REFERENCE TO RELATED APPLICATIONS

The present application claims priority to and incorporates by reference the entire contents of Japanese Patent Application No. 2014-167793 filed in Japan on Aug. 20, 2014.

### BACKGROUND OF THE INVENTION

1. Field of the Invention

The present invention relates to a response generation device, a response generation method, and a non-transitory computer readable storage medium having stored therein a response generation program.

2. Description of the Related Art

An interactive agent system has been known. When receiving a message from a user terminal, the interactive agent system outputs a message responding to the received message to the user terminal. A technique, for example, to output various messages in response to a message received from the user terminal, or to output a message appropriate for the user of the user terminal is provided in such an interactive agent system. For example, a technique is proposed as follows. The technique is to change the rule of user interaction in the interactive agent system in conformity with the user's taste and in accordance with a user's interest category determined based on the history of the user's behavior on the web, and a category of a message corresponding to each node without imposing a burden on the user.

However, the existing technique described above does not necessarily output a message appropriate for the user. For example, the existing technique may bring an uncomfortable feeling to a user who does not like a small talk by outputting a response message that deviates from the context of the user interaction to the user. As described above, the existing technique does not necessarily output a message appropriate for the user.

### SUMMARY OF THE INVENTION

It is an object of the present invention to at least partially solve the problems in the conventional technology.

The response generation device according to the present invention includes: a determination unit that determines a trend in progress of user interaction between an interactive agent system and a user; and an output control unit that controls output so as to output a response message in accordance with the trend in progress of the user interaction determined by the determination unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of an exemplary response generating process according to an embodiment;

FIG. 2 is a diagram of an exemplary configuration of the response generation system according to the embodiment;

FIG. 3 is a diagram of an exemplary configuration of an advertisement bid device according to the embodiment;

FIG. 4 is a diagram of an exemplary advertisement information storage unit according to the embodiment;

FIG. 5 is a diagram of an exemplary configuration of the response generation device according to the embodiment;

FIG. 6 is a diagram of an exemplary determination information storage unit according to the embodiment;

FIG. 7 is a schematic diagram of the tree structure stored in the determination information storage unit;

FIG. 8 is a flowchart of the procedures of an advertisement bidding process with the response generation device according to the embodiment; and

FIG. 9 is a diagram of the hardware configuration of an exemplary computer that implements the functions of the response generation device.

### DETAILED DESCRIPTION OF THE PREFERRED EMBODIMENTS

Aspects (hereinafter, referred to as “embodiments”) for implementing a response generation device, response generation method, and non-transitory computer readable storage medium having stored therein a response generation program that are according to the present invention will be described in detail hereinafter with reference to the appended drawings. Note that the response generation device, response generation method, and response generation program according to the present invention are not limited to the embodiments. Furthermore, the same components will be put with the same reference signs and the overlapping descriptions will be omitted hereinafter in each of the embodiments.

1. Response Generating Process

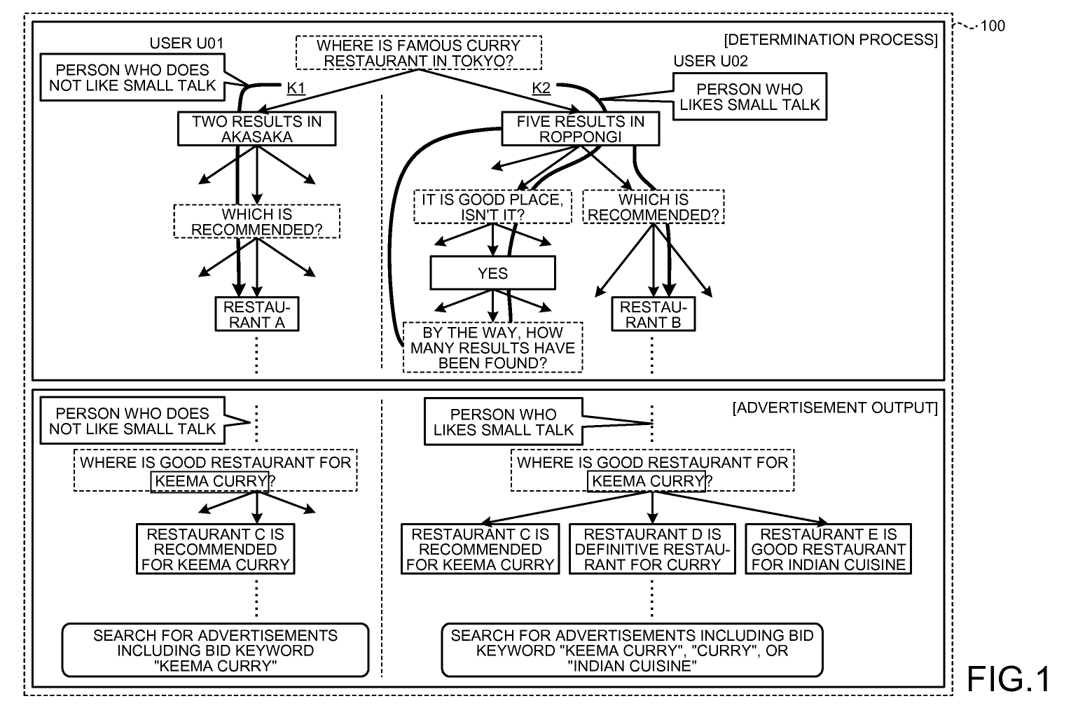

First, an exemplary response generating process to be described according to an embodiment will be described with reference to FIG. 1. FIG. 1 is a diagram of an exemplary response generating process according to the embodiment. FIG. 1 illustrates an example in which a response generation device 100 performs a response generating process.

The response generation device 100 implements the user interaction by outputting a response message to an input message that is a speech by the user in accordance with the preset determination information. Hereinafter, the determination information according to the embodiment has a tree structure (hereinafter, sometimes referred to as a “determination tree”) formed by nodes corresponding to input messages and the response messages.

Specifically, the response generation device 100 specifies the tendency that the user has when the user moves a conversation (hereinafter, sometimes referred to as a “conversation tendency”) using a determination tree as illustrated in FIG. 1 to determine a characteristic of the user in accordance with the specified tendency in a conversation. The response generation device 100 assorts the control on the outputs of the advertisement information that is to be the response messages in accordance with the characteristic of the user. Note that an example in which the response generation device 100 determines the personality of the user as the characteristic of the user will be described in the following embodiment.

1-1. User's Characteristic Determination Process

First, exemplary procedures related to the determination of the user's personality in the response generating process according to the embodiment will be described with reference to FIG. 1. In the determination tree illustrated in FIG. 1, the detection nodes are shown in the blocks with a dotted line, and the operation nodes are shown in the blocks with a solid line. The detection nodes determine the procedures of the process corresponding to the input message from the user, and the operation nodes determine the procedures of the process corresponding to the response message. For example, predetermined keywords are set in the detection nodes such that the operation node corresponding to the response is selected by determining whether the predetermined keywords related to the input message by the user are included in the operation node. As described above, the response generation device 100 implements the user interaction with the detection nodes and the operation nodes.

For example, the response generation device 100 determines whether the keyword set in the detection node is included in the input message by a user U01 “Where is a famous curry restaurant in Tokyo?” as illustrated in FIG. 1. When the keyword is included in the input message, the response generation device 100 starts the user interaction.

Subsequently, the response generation device 100 outputs a response message corresponding to the operation node connected to the detection node, for example, the response message “two results in Akasaka” or “five results in Roppongi”. Subsequently, the response generation device 100 determines whether the input message by the user U01 includes any one of the keywords set in a plurality of detection nodes connected to the operation node corresponding to the response message. When determining that the input message includes a keyword, the response generation device 100 outputs a response message corresponding to the operation node connected to the detection node corresponding to the keyword. As described above, the response generation device 100 implements the user interaction with the user by using the detection nodes and the operation nodes.

Furthermore, the response generation device 100 counts the number of times that each node is used every time the response generation device 100 uses a detection node or an operation node. Specifically, the response generation device 100 extracts the most-used node in the sequence of user interaction. Accordingly, the response generation device 100 determines the user's personality by determining whether the number of times that the most-used node is used exceeds a predetermined threshold. For example, the response generation device 100 sets “two” as the threshold. When the number of times that the most-used node is used is less than “two”, the response generation device 100 determines that the user of the user interaction does not easily change the topic, in other words, the user does not like a small talk. Alternatively, when the number of times that the most-used node is used is equal to or more than “two”, the response generation device 100 determines that the user easily changes the topic, in other word, the user likes a small talk.

Thus, based on the threshold, the response generation device 100 sets the determination criteria, for example, “the number of times that the most-used node is used: less than twice→the conversation tendency: not to easily change the topic→the personality: the user does not like a small talk” and “the number of times that the most-used node is used: equal to or more than twice→the conversation tendency: to easily change the topic→the personality: the user likes a small talk”.

For example, focusing on a curve K1 indicating the flow of the user interaction of the user U01, the response generation device 100 uses each of the nodes corresponding to four messages “Where is a famous curry restaurant in Tokyo?”, “Two results in Akasaka”, “Which is recommended?”, and “Restaurant A”, “once” by the end of the user interaction. The response generation device 100 determines the conversation tendency of the user U01 in the example as “not to easily change the topic” in accordance with the determination criteria. Accordingly, the response generation device 100 determines that the user U01 “does not like a small talk”.

From the fact that the user uses each node only once in a sequence of user interaction as described above, the response generation device 100 predicts that the user U01 moves the conversation in relatively faithful accordance with the preset conversation tree, in other words, that the user U01 does not easily change the topic and has a conversation tendency to ask only a clear answer, for example, to the user's question. Thus, the response generation device 100 can determine that the user U01 does not like a small talk.

On the other hand, in the example illustrated in FIG. 1, a user U02 starts the user interaction with the input message “Where is a famous curry restaurant in Tokyo?” and the user interaction moves with the messages, for example, “Five results in Roppongi”, “It is a good place, isn't it?”, “Yes”, “By the way, how many results have been found?”, “Five results in Roppongi”, “Which is recommended?”, and “Restaurant B”. Focusing on a curve K2 indicating the flow of the user interaction, the response generation device 100 uses the operation node “Five results in Roppongi” twice. Specifically, the response generation device 100 uses the operation node “Five results in Roppongi” again because the user U02 asks the question “By the way, how many results have been found?” again. The operation node “Five results in Roppongi” is used. Thus, the response generation device 100 counts the number of times that the operation node “Five results in Roppongi” is used as “twice”. Subsequently, the response generation device 100 determines that the user U02 has the conversation tendency “to easily change the topic” in accordance with the determination criteria. Accordingly, the response generation device 100 determines that the user U02 “likes a small talk”.

From the fact that the response generation device 100 uses a predetermined node more than once in a sequence of user interaction as described above, it is found that the user U02 expects various response messages from the response generation device 100 and tries to enjoy the user interaction. For example, the user may ask the question again merely because the user misses the information in the example in FIG. 1. However, it can also be assumed from the repeated question that the user expects how the response generation device 100 responds and tries to enjoy the user interaction with the response generation device 100 more. Accordingly, the response generation device 100 can determine that the user U02 “likes a small talk”.

Note that, not only the example illustrated in FIG. 1 in which the user asks the question again, but also there are various types of examples in which a predetermined node is used more than once in a sequence of user interaction. In other words, the number of times that the predetermined node is used increases as the user interaction spreads. In other words, the response generation device 100 can determines that a user who moves the user interaction in such a manner easily changes the topic and likes various types of user interaction including a small talk. The response generation device 100 does not need to determine that the user “likes a small talk” when a predetermined node is used twice or more. The response generation device 100 can arbitrarily set the threshold for the number of times that a node is used, and the user's conversation tendency and personality that correspond to the node.

Herein, the example in which the user's personality is determined from the conversation tendency based on the number of times that a predetermined node is used has been described. However, the embodiment is not limited to the example. As described below, the user's personality can be determined, for example, from a combination of nodes, the total number of nodes specified until the user interaction is completed, the period between the time when a predetermined node is used and the time when the next node is used, or the time required to complete the user interaction, or the user's personality can comprehensively be determined from a combination of them.

1-2. Advertisement Outputting Process

An exemplary advertisement outputting process for outputting the information about advertisement information as a response message in the response generating process according to the embodiment will be described next with reference to FIG. 1. Note that the advertisement outputting process is performed in parallel to the determination process.

First, an example in which the response generation device 100 controls the output of the advertisement information as a response message in the user interaction between the user U01 who is determined as “a person who does not like a small talk” in the personality determination process, and the response generation device 100.

Every time receiving an input message from the user, the response generation device 100 determines a predetermined keyword included in a detection node corresponding to the received input message as a search keyword for searching for an advertisement.

If receiving an input message such as “Where is a good restaurant for keema curry?” from the user U01 as illustrated in FIG. 1, the response generation device 100 determines the word “keema curry” included in the detection node corresponding to the received input message as a search keyword.

In this example, the user U01 is determined as “a person who does not like a small talk”. Thus, the user U01 may get an uncomfortable feeling with a response message deviating from the context of the user interaction. In light of the foregoing, the response generation device 100 outputs the advertisement information that works as a response message that does not deviate from the context of the user interaction. In other words, the response generation device 100 narrows the scope of the search by using the search keyword “keema curry”. In other words, the response generation device 100 searches for the advertisement information having a close similarity to the word “keema curry”.

Specifically, the response generation device 100 searches for the advertisement information using the search keyword “keema curry” and obtains the advertisement data item in which the word “keema curry” is set as a bid keyword. Subsequently, the response generation device 100 controls the output such that the obtained advertisement data item is output as the response message. For example, when an advertiser Restaurant C bids for the advertisement information including the bid keyword “keema curry” and the advertisement data item “Restaurant C is recommended for keema curry”, the response generation device 100 obtains the advertisement data item of the advertiser Restaurant C with the searching method, and controls the output so as to output the response message “Restaurant C is recommended for keema curry”.

As described above, the response generation device 100 controls the output so as to output the advertisement information obtained with a predetermined keyword included in the input message by the user U01 who is determined as “a person who does not like a small talk” for the user U01 as the response message to the user U01. This response message is consistent with the context of the user interaction, and thus does not give an uncomfortable feeling to the user U01 who does not like a small talk. Specifically, the response generation device 100 does not deviate from the context of the user interaction and does not give an uncomfortable feeling to the user because the response generation device 100 outputs the response message related to “keema curry” to the user U01 having the user interaction about “keema curry”.

On the other hand, an example in which the response generation device 100 outputs the advertisement information as a response message in the user interaction between the user U02 who is determined as “a person who likes a small talk” in the personality determination process, and the response generation device 100.

It can be considered that the user U02 wants to enjoy various types of user interaction with the response generation device 100 because the user U02 is determined as “a person who likes a small talk”. In other words, it can be considered that a response message deviating from the context of the user interaction does not give an uncomfortable feeling to the user. Thus, the response generation device 100 can control the output so as to output also the advertisement information that works as a response message deviating from the context of the user interaction on purpose. In other words, the response generation device 100 expands the scope of the search by using not only the search keyword “keema curry” but also a similar search keyword that is a word related to the search keyword. In other words, the response generation device 100 searches for the advertisement information having a loose similarity while including the word “keema curry” in the scope of the search.

When receiving the input message “Where is a good restaurant for keema curry?” from the user U02 as illustrated in FIG. 1, the response generation device 100 determines the word “keema curry” included in the user interaction with the user U02 as a search keyword. Furthermore, the response generation device 100 searches for words related to the search keyword to determine the related words as similar search keywords. The response generation device 100 sets, for example, the words “curry” and “Indian cuisine” as the search keywords similar to the word “keema curry”. Note that, when the response generation device 100 performs a process for searching for related words, an arbitrary publicly-known technique is used.

In this example, the response generation device 100 searches the scope using the words “keema curry”, “curry”, and “Indian cuisine” to obtain the advertisement data items in which the words “keema curry”, “curry”, and “Indian cuisine” are set as the bid keywords. Then, the response generation device 100 controls the output so as to output the obtained advertisement data items as the response messages. For example, the advertisers Restaurant C, Restaurant D, and Restaurant E bid for the advertisement information such as “keema curry: Restaurant C is recommended for keema curry”, “curry: Restaurant D is a definitive restaurant for curry”, “Indian cuisine: Restaurant E is a good restaurant for Indian cuisine”, respectively, as the bid keywords and the advertisement data items. The response generation device 100 obtains the advertisement data item of each of the advertisers with the searching method and controls the output so as to output the advertisement data item as the response messages.

Note that, when obtaining a plurality of types of advertisement information as illustrated in FIG. 1, the response generation device 100, for example, can check the information to be output against the user attribution, can determine the advertisement information to be output depending on the unit price of bidding, can determine one of the types of information at random, or can control the output so as to sequentially output all of the types of information.

As described above, the response generation device 100 controls the output so as to output the advertisement data items obtained from the search with the keyword included in the input message by the user U02 and the related words related to the keyword as the response messages to the user U02 who is determined as “a person who likes a small talk”. The response messages output in such a manner may deviate from the context of the user interaction in comparison with the response message obtained from the search with the search keyword. In other words, the response generation device 100 sometimes merely outputs the response messages about “curry” and “Indian cuisine” to the user U02 who has the user interaction about “keema curry” as illustrated in FIG. 1. As described above, the response generation device 100 can provide various topics to the user U02 and increase the user U02's satisfaction level with the user interaction by outputting the response messages deviating from the context of the user interaction to the user U02 who is determined as “a person who likes a small talk” on purpose.

As described above, the response generation device 100 determines the user's personality based on the tendency in the user interaction. Then, the response generation device 100 assorts the control of the output of the advertisement information that is to be response messages in accordance with the determined personality. For example, the response generation device 100 controls the output so as to output the response message along the context of the user interaction to the user who is determined as “a person who does not like a small talk” such that the topic is not switched. Alternatively, the response generation device 100 sometimes controls the output so as to output a response message deviating from the context of the user interaction to the user who is determined as “a person who likes a small talk” because the topic can be switched. Thus, the response generation device 100 can control the output so as to output the response message appropriate for the user's personality, and thus can increase the user's satisfaction level with the user interaction.

2. Configuration of Response Generation System

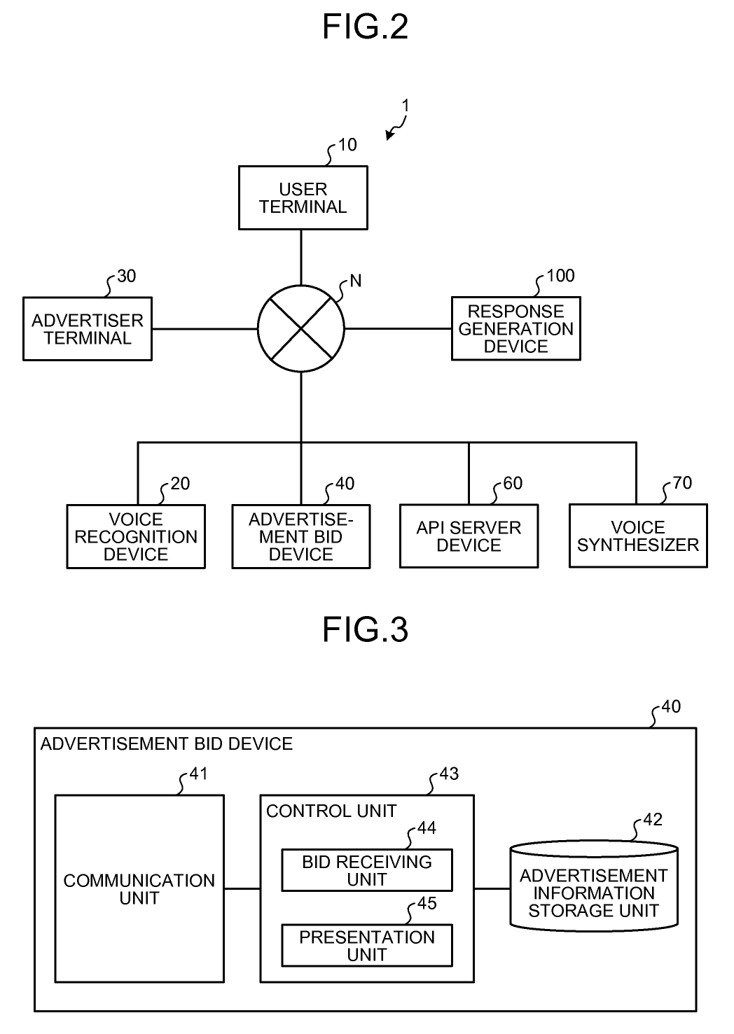

The configuration of the response generation system according to the embodiment will be described next with reference to FIG. 2. FIG. 2 is a diagram of an exemplary configuration of a response generation system 1 according to the embodiment. As illustrated in FIG. 2, the response generation system 1 includes a user terminal 10, a voice recognition device 20, an advertiser terminal 30, an advertisement bid device 40, an API server device 60, a voice synthesizer 70, and a response generation device 100. The user terminal 10, the voice recognition device 20, the advertiser terminal 30, the advertisement bid device 40, the API server device 60, the voice synthesizer 70, and the response generation device 100 are connected to each other and can communicate with each other through a wired or wireless network N. Note that the response generation system 1 illustrated in FIG. 2 can include a plurality of user terminals 10 and a plurality of advertiser terminals 30.

A process for providing a voice service to the user with the response generation system 1 will briefly be described hereinafter. The user terminal 10 is an information processing apparatus such as a mobile phone, a smartphone, a Personal Digital Assistant (PDA), a table PC, a laptop PC, or a desktop PC. Note that the user terminal 10 can be applied to a robot that performs the user interaction, an information processing apparatus included in such a robot, or another arbitrary device installed on a robot. When the user terminal 10 detects a speech by the user after an application starts, the user terminal 10 transmits the voice data of the speech to the voice recognition device 20.

When receiving the voice data of the speech from the user terminal 10, the voice recognition device 20 converts the voice data into text data, and transmits the text data of the speech to the user terminal 10. After receiving the text data of the speech from the voice recognition device 20, the user terminal 10 transmits the text data of the speech to the response generation device 100.

The advertiser terminal 30 is a terminal device used by the advertiser. The advertiser terminal 30 is, for example, a mobile phone such as a smartphone, a tablet terminal, a PDA, a desktop PC, or a laptop PC. The advertiser terminal 30 transmits the advertisement information received from the advertiser to the advertisement bid device 40. Note that the advertisement information, for example, includes a bid keyword or an advertisement data item.

The advertisement bid device 40 inputs a bidding screen to the advertiser terminal 30. The advertisement bid device 40 stores the advertisement information received from the advertiser terminal 30 in a storage unit to be described below.

The response generation device 100 implements the user interaction with the user usually by basically performing a process to be described below.

For example, when receiving the text data of the speech from the user terminal 10, the response generation device 100 generates a response message by performing the determination process. To output the results, for example, from an image search or route search based on the speech by the user as a response message, the response generation device 100 designates the search condition for searching for the data necessary to generate the response message, and requests the data to the API server device 60 that is an application that the user terminal 10 starts.

The API server device 60 transmits the data including the results from the image search or the route search to the response generation device 100 in accordance with the search condition received from the response generation device 100. For example, the API server device 60 performs a process for obtaining the Extensible Markup Language (XML) data including the results from the image search or the route search to transmit the obtained XML data to the response generation device 100.

When receiving, for example, XML data from the API server device 60, the response generation device 100 extracts data from the XML data and converts the XML data into HTML data. Meanwhile, the response generation device 100 extracts text data used for a voice response (hereinafter, referred to as response speech displaying text data) from the XML data or the HTML data. Furthermore, the response generation device 100 transmits the response speech displaying text data or the text data of the response message obtained in the determination process to the voice synthesizer 70. The voice synthesizer 70 transmits, to the response generation device 100, intermediate indication for the response speech generated in a voice synthesizing process for synthesizing a voice from the response speech displaying text data or the text data of the response message obtained in the determination process. The response generation device 100 transmits the intermediate indication for the response speech, the response speech displaying text data, and the HTML data to the user terminal 10.

The user terminal 10 outputs the response voice using the received intermediate indication for the response speech. Meanwhile, the user terminal 10 displays the contents of the response using the response speech displaying text data and the HTML data. As described above, the response generation system 1 implements the voice service that provides a response appropriate to the speech by the user.

Note that, when performing the determination process, the response generation device 100 implements the output of the response message in accordance with the user's personality by combining the response generating process with the determination process. For example, the response generation device 100 extracts a keyword from the speech by the user, and transmits the extracted keyword as the search keyword to the advertisement bid device 40. In the implementation, the advertisement bid device 40 searches for the advertisement corresponding to the search keyword, and transmits the search result to the response generation device 100. Subsequently, the response generation device 100 transmits the text data of the received advertisement to the voice synthesizer 70 to obtain the intermediate indication for the response speech. Then, the response generation device 100 transmits the obtained intermediate indication and the text data of the advertisement to the user terminal 10.

3-1. Configuration of Advertisement Bid Device

The advertisement bid device 40 according to the embodiment will be described next with reference to FIG. 3. FIG. 3 is a diagram of an exemplary configuration of the advertisement bid device 40 according to the embodiment. As illustrated in FIG. 3, the advertisement bid device 40 includes a communication unit 41, an advertisement information storage unit 42, and a control unit 43.

The communication unit 41 is implemented, for example, with a Network Interface Card (NIC). The communication unit 41 is connected to a network with a wired or wireless communication.

The advertisement information storage unit 42 is implemented, for example, with a semiconductor memory device such as a Random Access Memory (RAM), or a Flash Memory, or a storage device such as a hard disk or an optical disk.

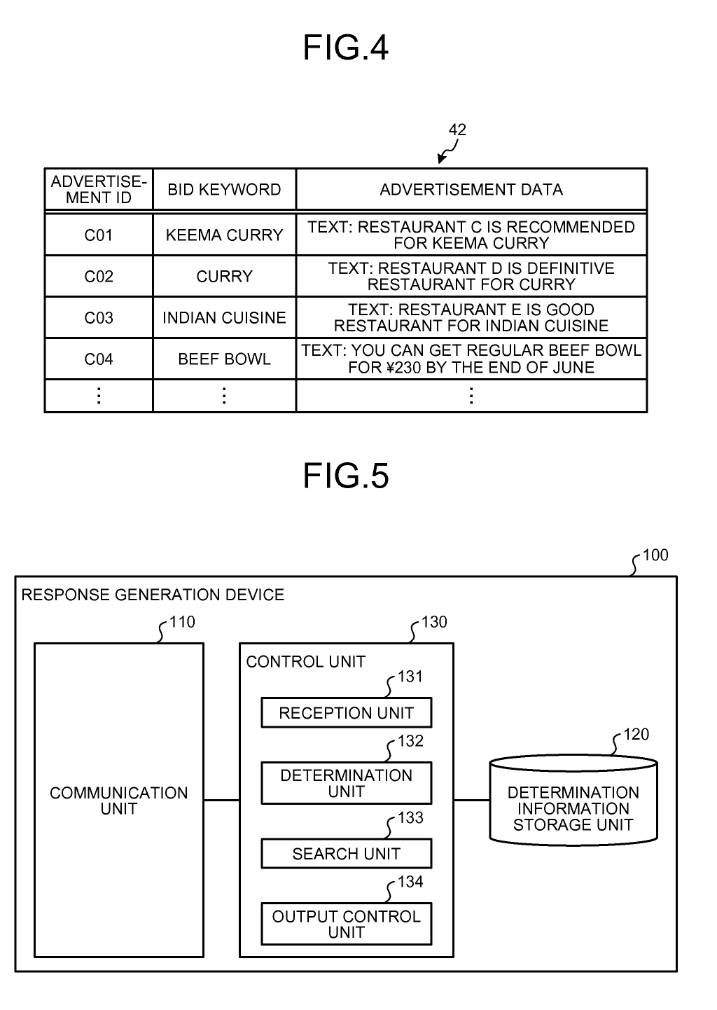

The advertisement information storage unit 42 stores various types of advertisement information. Specifically, the advertisement information storage unit 42 stores the advertisement information received as a bid from the advertiser terminal 30. FIG. 4, herein, illustrates an exemplary advertisement information storage unit 42 according to the embodiment. In the example illustrated in FIG. 4, the advertisement information storage unit 42 stores an advertisement ID, a bid keyword and an advertisement data item while linking them to each other.

The “advertisement ID” indicates identification information for identifying the advertisement information. The “advertisement ID” is the identification information also for identifying the advertiser and the advertiser terminal 30. The “bid keyword” is a keyword set by the advertiser. For example, the advertiser sets a word that characterizes the item or information to be advertised as the bid keyword.

The “advertisement data item” is an advertisement copy set by the advertiser, and is submitted, for example, in a text data format. Note that the advertisement bid device 40 can set the number of characters.

In other words, FIG. 4 illustrates that the advertiser (for example, Restaurant C) identified with the advertisement ID “C01” gives an instruction by setting the bid keyword “keema curry” such that the response message “Restaurant C is recommended for keema curry!” is output when the user inputs a message including the word “keema curry”.

With reference to FIG. 3 again, for example, a Central Processing Unit (CPU) or a Micro Processing Unit (MPU) executes various programs stored in a storage unit in the advertisement bid device 40 (the programs correspond to exemplary advertisement bidding programs) using a Random Access Memory (RAM) as a work area. This execution implements the control unit 43. Alternatively, the control unit 43 is implemented, for example, with an integrated circuit such as an Application Specific Circuit (ASIC) or a Field Programmable Gate Array (FPGA).

As illustrated in FIG. 3, the control unit 43 includes a bid receiving unit 44 and a presentation unit 45 to implement or execute an information processing function or action to be described below. Note that the internal configuration of the control unit 43 is not limited to the configuration illustrated in FIG. 3, and can be any other configuration as long as the control unit 43 can process information as described below. Furthermore, the control unit 43 can be connected to each processing unit not only in the manner illustrated in FIG. 3 but also in another manner.

The bid receiving unit 44 receives a bid for the advertisement information including the bid keyword and the advertisement data item from the advertiser by inputting a predetermined bidding screen to the advertiser terminal 30. Subsequently, the bid receiving unit 44 stores the received advertisement information in the advertisement information storage unit 42.

The presentation unit 45 inputs the advertisement data item found by the response generation device 100 in response to a request for obtaining the data item from a search unit 133. Specifically, the presentation unit 45 receives the search keyword from the response generation device 100 to search the advertisement data items in the advertisement information storage unit 42 using the received search keyword. Specifically, the presentation unit 45 extracts the advertisement data item of which bid keyword corresponds to the search keyword from the advertisement information storage unit 42 to input the extracted advertisement data item to the response generation device 100 that is the source of the search keyword.

3-2. Configuration of Response Generation Device

The response generation device 100 according to the embodiment will be described next with reference to FIG. 5. FIG. 5 is a diagram of an exemplary configuration of the response generation device 100 according to the embodiment. As illustrated in FIG. 5, the response generation device 100 includes a communication unit 110, a determination information storage unit 120, and a control unit 130.

The communication unit 110 is implemented, for example, with a NIC. The communication unit 110 is connected to a network in a wired or wireless communication.

The determination information storage unit 120 is implemented, for example, with a semiconductor memory device such as a RAM or a flash memory, or a storage device such as a hard disk, or an optical disk. The determination information storage unit 120 stores the determination information used to determine a response message to the response message by the user. The determination information is the tree-structured data including the detection node that prescribes a process for the input message, the operation node that prescribes a process for the response message, and an edge indicating the relationship of connection between the detection node and the operation node.

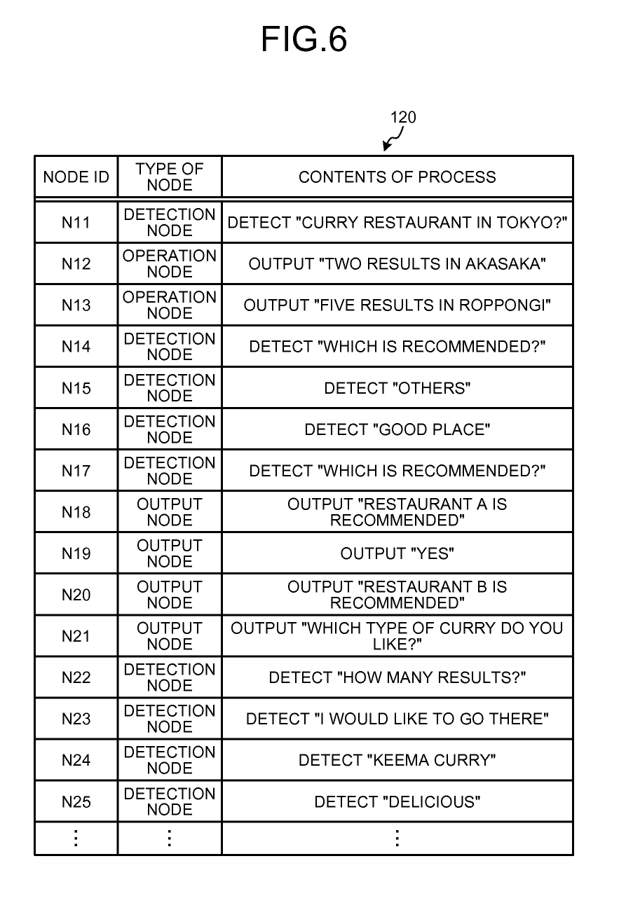

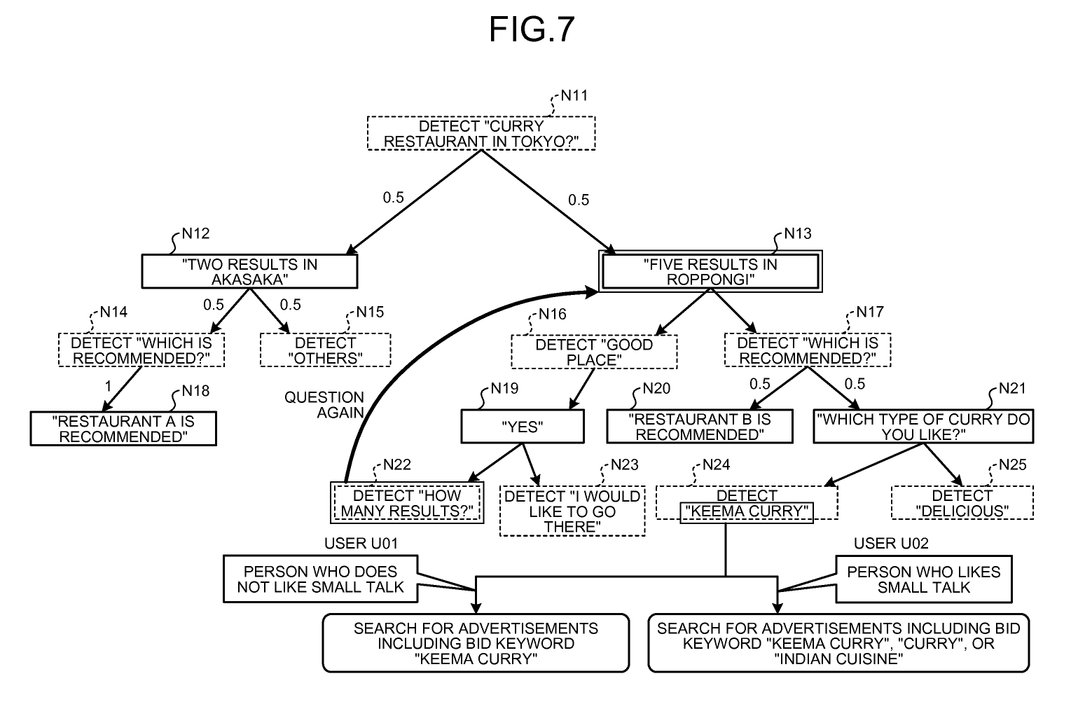

FIG. 6 illustrates, herein, an exemplary determination information storage unit 120 according to the embodiment. In the example illustrated in FIG. 6, a node ID that identifies each node, a node type indicating a type of the node, and the contents of process indicating the procedures in the process for the message are linked to each other and stored. Note that, although not illustrated in FIG. 6, the information indicating which node is connected to each node is registered in the determination information storage unit 120. For example, a node of which node ID is “N11” is connected to both of nodes of which node ID are “N12” and “N13” in the determination information storage unit 120. The transition probability that is the probability of transition from the node of the node ID “N11” to one of the nodes of node ID “N12” and node ID “N13” is “0.5”. As a result, the determination information storage unit 120 stores the data having the tree structure illustrated in FIG. 7.

FIG. 7 is a schematic diagram of the tree structure stored in the determination information storage unit 120. The detection nodes are shown in the blocks with dashed lines, and the operation nodes are shown in the blocks with the solid lines illustrated in FIG. 7. Furthermore, a node ID is attached to each of the blocks. Each arrow between the nodes is an edge. Specifically, the node at the starting point of the arrow (the end of the arrow) is the connection source node, and the node at the ending point of the arrow (the top of the arrow) is the connection destination node. For example, the arrow from the node of the node ID “N11” to the node of the node ID “N12” indicates that the connection source node is the detection node of which node ID is “N11”, and the connection destination node is the operation node of which node ID is “N12”. Note that the determination tree corresponds to the determination tree illustrated in FIG. 1, and it can be said that the determination tree further clarifies, for example, the process in each node. Note that each illustrated numerical value (for example, 0.5) indicates the transition probability. The determination tree schematically illustrated in FIG. 7 indicates only some nodes of the detection nodes and operation nodes stored in the determination information storage unit 120. Not only the nodes illustrated in FIG. 6 and FIG. 7 but also various detection nodes and operation nodes other than are connected in the determination information storage unit 120.

Thus, when the response generation device 100 determines that the node corresponding to the user's input message “Where is a famous curry restaurant in Tokyo?” is the node of the node ID “N11”, the node transits to one of the operation nodes of the node ID “N12” and node ID “N13” that are the connection destination nodes.

With reference to FIG. 5 again, for example, a CPU or an MPU executes various programs stored in a storage unit in the response generation device 100 (the programs correspond to exemplary response generation programs) using a RAM as a work area. This execution implements the control unit 130. Alternatively, the control unit 130 is implemented, for example, with an integrated circuit such as an ASIC or a FPGA.

As illustrated in FIG. 5, the control unit 130 includes a reception unit 131, a determination unit 132, a search unit 133, and an output control unit 134 to implement or execute an information processing function or action to be described below. Note that the internal configuration of the control unit 130 is not limited to the configuration illustrated in FIG. 5, and can be any other configuration as long as the control unit 130 can process information as described below. Furthermore, the control unit 130 can be connected to each processing unit not only in the manner as illustrated in FIG. 5 but also in another manner.

The reception unit 131 receives various types of information from the user terminal 10, the API server device 60, and the voice synthesizer 70 as described above. The reception unit 131 further receives the determination information created by an external device (not illustrated) and stores the determination information in the determination information storage unit 120.

The determination unit 132 determines the user's characteristics from the trend in progress of the user interaction. Specifically, the determination unit 132 counts the number of times that each node is used every time the response generation device 100 uses a detection node or an operation node. Then, the determination unit 132 determines the trend in progress of the user interaction based on the number of times that each node is used. The determination unit 132 determines various user's characteristics such as the user's personality or feeling in accordance with the trend in progress of the user interaction.

Based on the number of times that a predetermined node is used in a sequence of user interaction between the user and the response generation device 100, the determination unit 132 determines the user's characteristics in accordance with the tendency that the user has when the user moves the user interaction as described with reference to FIG. 1. Specifically, the determination unit 132 determines the user's personality by extracting the most-used node from the series of user interaction and determining whether the number of times that the most-used node is used exceeds a predetermined threshold. For example, the response generation device 100 sets “two” as the threshold. When the number of times that the most-used node is used is less than two, the response generation device 100 determines that the user does not easily change the topic, in other words, does not like a small talk. Alternatively, when the number of times that the most-used node is used is equal to or more than two, the response generation device 100 determines that the user easily changes the topic, in other words, likes a small talk.

Thus, based on the threshold, the response generation device 100 sets the determination criteria, for example, “the number of times that the most-used node is used: less than twice→the conversation tendency: not to easily change the topic→the personality: the user does not like a small talk” and “the number of times that the most-used node is used: equal to or more than twice→the conversation tendency: to easily change the topic→the personality: the user likes a small talk”.

In the example of FIG. 7, from the time when the user U01 starts to the time when the user interaction is completed, the determination unit 132 counts the number of times that each node is used every time the response generation device 100 uses a detection node or an operation node. For example, when the user interaction moves in order of “N11”→“N12”→“N14”→“N18”, the determination unit 132 holds the count results “N11: once”, “N12: once”, “N14: once” and “N18: once”. Then, the determination unit 132 compares the determination criteria to the count results. The number of times that each of the nodes is used is less than the threshold. Thus, the determination unit 132 determines that the user U01 has the conversation tendency not to easily change the topic, in other words, “does not like a small talk”.

On the other hand, an example in which the user U02 who uses a user terminal 10 different from that of the user U01 starts user interaction will be described. For example, when the user interaction moves in order of “N11”→“N13”→“N16”→“N19”→“N22”→“N13”→“N17”→“N20”, the determination unit 132 holds the count results “N11: once”, “N13: twice”, “N16: once”, “N17: once”, “N19: once”, “N22: once”, and “N20: once”. Then, the determination unit 132 compares the determination criteria to the count results.

In this example, the count result of the node “N13” is “twice”. The first time is the operation node as the response message to the node “N11”. The second times is the operation node as the response message to the node “N22”, for example, in which the user U02 inputs a question “how many results have been found?” again.

The number of times that the determination unit 132 uses the node “N13” is equal to or more than the threshold. As a result, the determination unit 132 determines that the user U02 has the conversation tendency to easily change the topic, in other words, “likes a small talk”.

Note that the determination unit 132 does not need to determine the user's personality from the comparison of the number of times that the most-used node is used to the threshold. When there is a plurality of nodes used more than once, for example, when the node “N13” is used twice, and the node “N17” is used twice, the determination unit 132 can determines the user's personality from the comparison of the total number of times that the nodes are used (namely, four times) to the threshold. Alternatively, the determination unit 132 can determines the user's personality in accordance with the number of nodes used more than once, or in accordance with whether a predetermined node is used more than once. Alternatively, the determination unit 132 can combine the determination methods. In other words, the determination unit 132 only has to determine whether the user interaction with the user satisfies a predetermined condition in order to determine the user's personality, and thus can use an arbitrary method to determine the user's personality.

Then, the determination unit 132 can store the user's characteristic obtained from the determination result in a predetermined storage unit (not illustrated). Note that the determination unit 132 can determine the user's characteristic from a sequence of the user interaction or a plurality of sequences of user interaction. A sequence of user interaction is, for example, the user interaction between the user and the response generation device 100 that is done during the period from the start to the completion of a predetermined application for the response generation system 1 in the user terminal 10. Note that the user's personality “to like a small talk” or “not to like a small talk” is not necessarily determined depending on the user's personality. The user's personality may vary, for example, depending on the situation of the user interaction. In light of the foregoing, the determination unit 132 predicts the situation in the user interaction with the user, for example, from the contents of the user interaction or the state of the user's voice, and then can determine the user's personality in consideration of the expected situation. The determination unit 132 gives the priority to the process for determining the user's personality in consideration of the situation. However, if the determination in consideration of the situation leads to an unclear result, the determination unit 132 can give the priority to the result from the process for determining the user's personality depending on the user's personality. If the user's personality frequently changes between the personality “not to like a small talk” and the personality “to like a small talk” through the whole user interaction, the determination unit 132 can give the priority to the process for determining the user's personality depending on the user's personality.

With reference to FIG. 5 again, the search unit 133 searches the advertisement information storage unit 42 for the advertisement information that is to be the response message in accordance with the user's characteristic determined with the determination unit 132. Specifically, the search unit 133 searches the narrowed scope of the search when the determination unit 132 determines that the user does not like a small talk. On the other hand, the search unit 133 searches the broadened scope of the search when the determination unit 132 determines that the user likes a small talk. As a result, the search unit 133 can output a response message that does not deviate from the context of the user interaction to the user who “does not like a small talk”, and can output also a response message deviating from the context of the user interaction to the user who “likes a small talk”. A specific process will be described with reference to FIG. 1 and FIG. 5.

The search unit 133 receives the information about the user's characteristic from the determination unit 132. Note that, when the user's characteristic is stored in a predetermined storage unit as described above, the search unit 133 can obtain the user's characteristic from the storage unit. An example in which the search unit 133 receives the user's personality as the user's characteristic will be described hereinafter.

An example in which the search unit 133 searches for the advertisement information that is to be the response message in the user interaction between the user U01 who is determined as “a person who does not like a small talk” in the personality determination process, and the response generation device 100 will be described first.

Every time the response generation device 100 uses a detection node, the search unit 133 determines a predetermined keyword included in the detection node as the search keyword for searching for an advertisement. Note that when the detection node includes a plurality of keywords, the search unit 133 can determine the most important keyword as the search keyword.

When the response generation device 100 uses the detection node including the word “keema curry” as described in the example of FIG. 1, the search unit 133 determines the word “keema curry” as the search keyword. The search unit 133 obtains the advertisement information linked to the bid keyword corresponding to the search keyword from the advertisement information storage unit 42.

Specifically, the search unit 133 transmits the search keyword to the advertisement bid device 40. When receiving the search keyword, the presentation unit 45 in the advertisement bid device 40 extracts the advertisement data item of which bid keyword corresponds to the search keyword, and inputs the extracted advertisement data item in the search unit 133. The search unit 133 obtains the input advertisement data item.

For example, when the advertisers bid for the advertisements illustrated in FIG. 4, respectively, the search unit 133 obtains the advertisement “Restaurant C is recommended for keema curry” as the advertisement data item including the bid keyword corresponds to the search keyword “keema curry” by transmitting the search keyword “keema curry” to the advertisement bid device 40.

When obtaining the advertisement data item from the presentation unit 45 in the advertisement bid device 40, the search unit 133 gives the output control unit 134 an instruction for controlling the output such that the advertisement data item is output as the response message. For example, the search unit 133 outputs the obtained advertisement data item “Restaurant C is recommended for keema curry” to the output control unit 134 in the example.

As described above, the narrowed scope is searched for a bid keyword corresponding to the search keyword. This search can provide only a response message having high relevance to the input message by the user U01 as the search result. Such a response message does not deviate from the context of the user interaction and does not give an uncomfortable feeling to the user U01 “who does not like a small talk”.

On the other hand, an example in which the search unit 133 searches for the advertisement information that is to be the response message in the user interaction between the user U02 who is determined as “a person who likes a small talk” in the personality determination process, and the response generation device 100.

Every time the response generation device 100 uses a detection node, the search unit 133 determines a predetermined keyword included in the detection node as the search keyword for searching for an advertisement. The search unit 133 sets a plurality of related words related to the search keyword as the similar search keywords. Note that the related words include broader terms and synonyms of the search keyword.

For example, when the response generation device 100 uses the detection node including the word “keema curry” as the example in FIG. 1, the search unit 133 determines the word “keema curry” as the search keyword. The search unit 133 further sets, for example, the words “curry” and “Indian cuisine” as the similar search keywords.

For example, when the advertisers bid for the advertisements illustrated in FIG. 4, respectively, the search unit 133 searches for the advertisement data items having a loose similarity using the search keyword “keema curry”, and the similar search keywords “curry” and “Indian cuisine”. Specifically, the search unit 133 transmits the search keyword and the similar search keywords to the advertisement bid device 40. The presentation unit 45 in the advertisement bid device 40 extracts the advertisement data items of which bid keywords correspond to the received search keyword or similar search keywords and inputs the extracted advertisement data items in the search unit 133. Then, the search unit 133 obtains the input advertisement data items. In other words, the search unit 133 obtains the words “Restaurant C is recommended for keema curry”, “Restaurant D is a definitive restaurant for curry”, and “Restaurant E is a good restaurant for Indian cuisine”.

When obtaining the advertisement data items from the presentation unit 45 in the advertisement bid device 40, the search unit 133 gives an instruction for outputting the advertisement data items as the response messages to the output control unit 134. For example, the search unit 133 checks the obtained advertisement data items “Restaurant C is recommended for keema curry”, “Restaurant D is a definitive restaurant for curry”, and “Restaurant E is a good restaurant for Indian cuisine” with the user attribution of the user U02 to output the advertisement data item selected in the matching (for example, the data item “Restaurant E is a good restaurant for Indian cuisine”) to the output control unit 134 in the example.

As described above, the scope of the search using a search keyword and similar search keywords is wider than that of the search using only a search keyword. The search using a search keyword and similar search keywords can provide response messages having low relevance to the input message by the user U02. Such response messages can deviate from the context of the user interaction. However, this enables the user U02 who “likes a small talk” to move the user interaction in various ways. This can increase the user's satisfaction with the user interaction as a result.

The output control unit 134 outputs the response message selected in accordance with the determination information in which a node related to a predetermined input message is linked to a node related to a predetermined response message. For example, when receiving an advertisement data item that is to be the response message from the search unit 133, the output control unit 134 transmits the advertisement data item to the voice synthesizer 70. When receiving the advertisement data item from the output control unit 134, the voice synthesizer 70 creates the intermediate indication (for example, the data of the reproduced waveform) and text of the advertisement data item, and transmits the intermediate indication and the text to the response generation device 100.

4. Flow of Response Generating Process

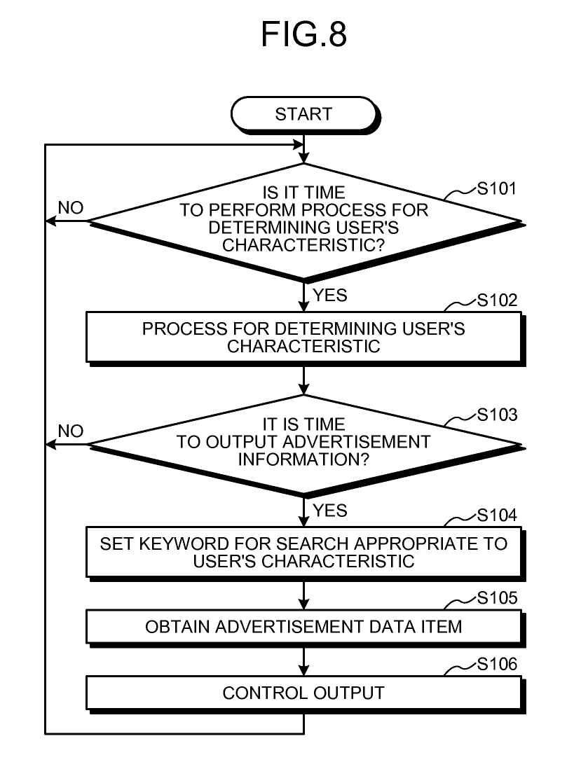

Next, the advertisement bidding process performed by the response generation device 100 according to the embodiment will be described with reference to FIG. 8. FIG. 8 is a flowchart of the advertisement bidding process performed by the response generation device 100 according to the embodiment.

As illustrated in FIG. 8, the determination unit 132 in the response generation device 100 determines whether it is the time to perform the process for determining the user's characteristic. For example, when the response generation device 100 uses a detection node or an operation node, the determination unit 132 determines that it is the time to determine the user's characteristic (step S101; Yes) and performs the process for determining the user's characteristic (step S102). Subsequently, when it is time to output the advertisement information (step S103; Yes), the search unit 133 in the response generation device 100 sets a keyword for the search appropriate for the user's characteristic determined in step S102 (step S104). Specifically, the search unit 133 sets the search keyword and the similar search keyword in accordance with the scope of the search set in accordance with the user's characteristic. Then, the search unit 133 obtains an advertisement data item corresponding to the set keyword for the search from the advertisement bid device 40 (step S105). Specifically, the search unit 133 transmits the set keyword for the search to the advertisement bid device 40. The advertisement bid device 40 subsequently extracts the advertisement data item including the bid keyword corresponding to the keyword, and obtains the extracted advertisement data item. Subsequently, the output control unit 134 in the response generation device 100 controls the output such that the advertisement data received from the search unit 133 is output as a voice (step S106).

5. Exemplary Variation

The response generation device 100 according the embodiment can be implemented with various embodiments different from the embodiment described above. Thus, other exemplary embodiments of the response generation device 100 will be described hereinafter.

5-1. User's Characteristic Determination (1)

The determination unit 132 in the response generation device 100 described above is an example in which the user's personality is determined as the user's characteristic from the trend in the user interaction based on the number of times that the response generation device 100 uses a predetermined node. However, the determination unit 132 can determine a predetermined user′ personality in accordance with the conversation tendency of the user based on the total number of nodes used by the response generation device 100 until the user interaction by the user is completed. This determination will be described with reference to FIG. 7.

Specifically, the determination unit 132 sets the threshold for the total number of nodes used by the response generation device 100. The determination unit 132 determines the user's personality from the conversation tendency obtained by determining whether the total number is less or more than the threshold. For example, the determination unit 132 sets “the total number: five times” as the threshold, and sets the determination criteria, for example, “the total number: less than five times→the conversation tendency: not to easily change the topic→the personality: the user does not like a small talk” and “the total number: equal to or more than five times→the conversation tendency: to easily change the topic→the personality: the user likes a small talk” based on the threshold.

The determination unit 132 counts the number of the used nodes every time the response generation device 100 uses a node until the response generation device 100 controls the output of the advertisement information. Specifically, the determination unit 132 consequently calculates the total number of the used nodes by adding a count “one” every time the response generation device 100 uses a detection node or an operation node. For example, when the user interaction with the user U01 moves in order of “N11”→“N12”→“N14”→“N18”, the number of the used nodes is “four”. As described above, it can be expected that the user interaction in which the total number of nodes is small has concise and comprehensive contents, and the topic is not variously changed in the user interaction. It can be determined that the user who moves user interaction in such a way does not like a small talk. From this, the determination unit 132 determines that the user U01 does not like a small talk. As a result, the determination unit 132 specifies the advertisement data item to be output by searching for an advertisement data item having close similarity to the keyword included in the response from the user U01 to the node “N18”.

On the other hand, when the user interaction with the user U02 moves in order of “N11”→“N13”→“N16”→“N19”→“N22”→“N13”→“N17”→“N20”, the total number of the nodes used by the response generation device 100 is “eight”. As described above, it can be predicted that the user interaction in which the total number of nodes is large is rich in content, or the topic is variously switched in the user interaction. It can consequently be determined that the user who moves user interaction in such a way likes a small talk. Thus, the determination unit 132 determines that the user U02 likes a small talk. As a result, the determination unit 132 specifies the advertisement data item to be output by searching for an advertisement data item having loose similarity to the keyword included in the response corresponding to the node “N20”.

5-2. User's Characteristic Determination (2)

Alternatively, the determination unit 132 in the response generation device 100 can determine the user's characteristic in accordance with the extent to which the user's input message is in agreement with the context of a sequence of user interaction including the input message.

In this example, the response generation device 100 previously links a predetermined category to each node. For example, when the response generation device 100 receives an input message from the user, and uses the detection node corresponding to the input message in a sequence of user interaction, the determination unit 132 calculates “the degree of agreement” of the category linked to the detection node and the category linked to the node used before the detection node. By this calculation, the determination unit 132 can determine the extent to which the input message of the detection node is in agreement with the previous context of the sequence of user interaction. Note that the degree of agreement is an index indicating the extent to which the input message is consistent with the context. The lower the value of the index is, the more largely the input message deviates from the context. When the input message is in absolute agreement with the context, the determination unit 132 gives the highest value “5” to the input message in this example.

Specifically, the determination unit 132 extracts the lowest degree of agreement in the sequence of user interaction. The determination unit 132 determines the user's personality as the user's characteristic by determining whether the lowest degree of agreement exceeds a predetermined threshold. For example, the response generation device 100 sets “three” as the threshold. When the extracted degree of agreement is equal to or higher than three, the response generation device 100 determines that the user of the user interaction does not easily change the topic, in other words, does not like a small talk. On the other hand, when the degree of agreement is lower than three, the response generation device 100 determines that the user of the user interaction easily changes the topic, in other words, likes a small talk.

For example, the user interaction with the user U02 moves in order of “N11”→“N13”→“N16”, and the user interaction with the user U01 moves in order of “N11”→“N13”→“N17” in FIG. 7. In this example, the response generation device 100 previously links a category such as N11 “curry restaurant: area”, N13 “curry restaurant: Roppongi”, N16 “Roppongi: affection”, or N17 “curry restaurant: recommendation” to each node.

In this example, from the fact that the sequence of user interaction with the user U01 flows in order of “N11”→“N13”→“N17”, the determination unit 132 determines that the user U01 constantly moves the user interaction along with the topic about curry restaurants, in other words, the input messages of the user U01 do not deviate from the context with reference to the exemplified categories. Subsequently, the determination unit 132 gives the degree of agreement “five” to the input messages. Consequently, the determination unit 132 determines that the user U01 “does not like a small talk” from the fact that the degree of agreement is equal to or higher than the threshold “three”.

On the other hand, from the fact that the sequence of user interaction with the user U02 flows in order of “N11”→“N13”→“N16”, the determination unit 132 gives the degree of agreement, for example, “two” to the input messages because the detection node “N16” corresponding to the input message by the user U02 deviates from the topic of a curry restaurant to the affection for Roppongi. Consequently, the determination unit 132 determines that the user U02 “likes a small talk” from the fact that the degree of agreement is lower than the threshold “three”.

As described above, the response generation device 100 determines the user's characteristic by determining the extent to which the context of the sequence of user interaction is in agreement with the input messages by the user in the user interaction.

5-3. User's Characteristic Determination (3)

Alternatively, the determination unit 132 in the response generation device 100 described above can determine the user's characteristic in accordance with the period of time from the time when the output of the response message is controlled to the time when a new input message is received from the user. This determination will be described with reference to FIG. 7.

Specifically, the determination unit 132 determines the user's personality corresponding to the conversation tendency in accordance with the period of time from the time when the response generation device 100 uses a predetermined node to the time when the response generation device 100 uses the next node. In other words, every time a node is used, the determination unit 132 measures the time elapsed until the next node is used. Then, the determination unit 132 measures the time for each node until the user interaction is completed and calculates the average time between the nodes at the time when the search for the advertisement information is conducted.

The determination unit 132 sets a threshold for the average time. The determination unit 132 determines the user's personality from the conversation tendency obtained by determining whether the average time is longer or shorter than the threshold. For example, the determination unit 132 sets “average time: 10 seconds” as the threshold and sets the determination criteria, for example, “average time: shorter than 10 seconds→the conversation tendency: not to easily change the topic→the personality: the user does not like a small talk” and “average time: equal to or longer than 10 seconds→the conversation tendency: to easily change the topic→the personality: the user likes a small talk” based on the threshold.

For example, when the average times are “N11”→“N12” (five seconds)→“N14” (four seconds)→“N18” (five seconds) in the user interaction with the user U01, the determination unit 132 calculates the average time as “seven seconds”. Subsequently, the determination unit 132 determines that the average time is shorter than the threshold by comparing the calculation result to the determination criteria. Thus, the determination unit 132 determines that the user U01 has a conversation tendency not to easily change the topic, in other words, does not like a small talk.

As described above, it can be expected that the user who moves the user interaction at a short average time tries to complete the user interaction briefly and shortly by responding quickly without changing the topic. Consequently, the user who moves the user interaction in such a way can be determined as a person who does not like a small talk.

On the other hand, when the average times are “N11”→“N13” (15 seconds)→“N16” (six seconds)→“N19” (21 seconds)→“N22” (18 seconds)→“N13” (10 seconds)→“N17” (10 seconds)→“N20” (10 seconds) in the user interaction with the user U02, the determination unit 132 calculates the average time as “14 seconds”. Subsequently, the determination unit 132 determines the average time is equal to or longer than the threshold by comparing the calculation result to the determination criteria. Thus, the determination unit 132 determines that the user U02 has a conversation tendency to easily change the topic, in other words, likes a small talk.

As described above, it can be predicted that the user who moves the user interaction at a long average time tries to carefully think and takes time for the topic to respond. It can be considered that the user who moves the user interaction in such a way tries to have user interaction rich in content. Consequently, the user can be determined as a person who likes various types of user interaction including a small talk.

5-4. User's Characteristic Determination (4)

Alternatively, the determination unit 132 in the response generation device 100 can determine the user's characteristic corresponding to the conversation tendency of the user in accordance with the total required time to find the advertisement information. Specifically, the determination unit 132 measures the period of time from the time when the response generation device 100 uses the first node to the time when the advertisement information is found. Note that the determination unit 132 can measure the period of time elapsed until the next node is used every time a node is used and sums the periods as the total required time. Similarly to the other examples, the determination unit 132 sets a threshold for the total required time, and determines the user's personality from the conversation tendency obtained by determining whether the total required time is shorter or longer than the threshold.

5-5. User's Characteristic Determination (5)

Alternatively, the determination unit 132 in the response generation device 100 described above can comprehensively determine the user's characteristic by combining the five determination methods described above. For example, the determination unit 132 determines the user's characteristics in each of the determination methods described above and gives one point to the determination result: the user does not like a small talk or the user likes a small talk. For example, when the determination unit 132 determines that the user does not like a small talk in the three determination methods among the five determination methods, and determines that the user likes a small talk in the other two determination methods, the determination unit 132 determines “the user does not like a small talk: three points” and “the user likes a small talk: two points”. Consequently, the determination unit 132 comprehensively determines that the user does not like a small talk.

5-6. Search (1)

The example in which the search unit 133 in the response generation device 100 described above searches a data item using a search keyword and similar search keywords as tags has been described. However, the search unit 133 can adjust the scope of the search in accordance with the degree of relevance between the search keyword and the contents of the advertisement.

Specifically, the search unit 133 sets a predetermined value for the degree of relevance. When the determination unit 132 determines that “the user does not easily change the topic and does not like a small talk”, the search unit 133 searches for an advertisement data item having a degree of relevance higher than the predetermined value. On the other hand, when the determination unit 132 determines that “the user easily changes the topic and likes a small talk”, the search unit 133 searches for an advertisement data item having a degree of relevance lower than the predetermined value.

5-7. Search (2)

Alternatively, the search unit 133 in the response generation device 100 described above can adjust the scope of the search based on the number of characters of the advertisement copy. Specifically, the search unit 133 sets a predetermined number of characters. When the determination unit 132 determines that “the user does not easily change the topic and does not like a small talk”, the search unit 133 searches for an advertisement data item formed from the number of characters smaller than the predetermined number of characters. On the other hand, when the determination unit 132 determines that “the user easily changes the topic and likes a small talk”, the search unit 133 searches for an advertisement data item formed from the number of characters larger than the predetermined number of characters.

This search can prevent the response generation device 100 from outputting a long response message and gives an uncomfortable feeling to the user who does not like a small talk, or from stopping the replay of the message halfway. On the other hand, the response generation device 100 can excite the user interaction by outputting a long response message to the user who likes a small talk. Note that when both the advertisement data item that is a long sentence and the advertisement data item that is a short sentence are registered for an object to be advertised, the response generation device 100 can output one of the data items in accordance with the user's characteristic. For example, the response generation device 100 can output a short advertisement of a product A to the user U01 who is determined as “a person who does not like a small talk” and can output a long advertisement of the product A to the user U02 who is determined as “a person who likes a small talk”.

5-8. Search (3)

Alternatively, the search unit 133 in the response generation device 100 described above can search for an advertisement data item in consideration of the positional information. Specifically, when receiving the user's characteristic determined by the determination unit 132, the search unit 133 obtains the positional information from the GPS device of the user terminal 10 of the user. Then, the search unit 133 preferentially outputs the advertisement data item of which positional information is in agreement with the obtained positional information or of which advertiser is located in a predetermined range from the obtained positional information among the advertisement data items input by the advertisement bid device 40. Note that the advertisement bid device 40 can previously receive the advertisement distribution area that the advertiser desires from the advertiser. By the reception, the search unit 133 can check the positional information of the advertisement data items against the obtained positional information in a matching and outputs the advertisement data item obtained from the matching to the output control unit 134. When a plurality of advertisement data items is obtained in the area, the search unit 133 can preferentially output the data item with a high unit price of bidding. Additionally, when the user likes a small talk, the search unit 133 can sequentially output the advertisement data items.

5-9. Additional Information

The search unit 133 in the response generation device 100 described above can generate predetermined additional information based on the user attribution and output the additional information together with the advertisement data item obtained from the search. For example, when obtaining the user's personality from the determination unit 132, the search unit 133 obtains the age of the user as the user's attribution from a predetermined storage unit. If the user is an elderly person, the search unit 133 can subsequently generate the detailed description about the advertisement data item obtained from the search and output the description together with the advertisement data item.

The search unit 133 can obtain the user's hobby or interest as the user attribution. If the advertisement data item obtained from the search has a high relevance to the hobby or interest, the search unit 133 can generate the additional information about the advertisement data item, and output the additional information together with the advertisement data. Note that the search unit 133 can generate the additional information based on various types of information previously received from the advertiser (for example, the information about a product), or based on the information obtained from a related website.

This additional information enables the response generation device 100 to increase the user's interest in the advertisement information, and thus can increase the advertising effectiveness. Note that the search unit 133 can add the additional information only when the determination unit 132 determines that the user likes a small talk. For example, when the user is an elderly person as described above, the search unit 133 can add the additional information regardless of the user's characteristic determined by the determination unit 132.

Alternatively, the response generation device 100 can specify the user's conversation tendency using other information. For example, recent user terminals 10 such as a smart device can obtain the biological information about the user, for example, the user's myoelectric activity (EMG: electromyography), eye movement, heart rate, or perspiration amount. Thus, the response generation device 100 can specify the user's conversation tendency in consideration of the biological information that the user terminal 10 obtains from the user. For example, when the user's heart rate is high, when the electric potential of the user's myoelectric activity increases, or when the user stares toward a predetermined direction, the response generation device 100 determines that the user tells a lie. The response generation device 100 can specify the conversation tendency on the assumption that the sequence of user interaction includes a lie. When the user's perspiration amount is larger than a predetermined threshold, the response generation device 100 can determine that the user is impatient. In other words, when the response generation device 100 can specify the user's conversation tendency, the response generation device 100 can use arbitrary information about the user. Note that the response generation device 100 can dynamically specify the user's conversation tendency in accordance with the arbitrary information (for example, the response generation device 100 specifies the user's conversation tendency again every time the user interaction moves ahead), or the response generation device 100 can statically specify the user's conversation tendency (for example, the response generation device 100 specifies the user's conversation tendency when a predetermined user interaction is done).

5-10. Configuration of Device

The example in which the response generation device 100 and the advertisement bid device 40 separately exist has been described in the embodiment. However, the advertisement bid device 40 can be integrated in the response generation device 100. In such a configuration, the response generation device 100 includes the advertisement information storage unit 42, bid receiving unit 44, and presentation unit 45 of the advertisement bid device 40.

5-11. Example Other than User Terminal

The example in which the user has user interaction with the response generation device 100 using the user terminal 10 has described in the embodiment. However, an interactive function with the response generation device 100 that the user terminal 10 has can be installed on a robot that performs user interaction. This installation enables the robot to have user interaction with the response generation device 100 in place of the user.

5-12. Program

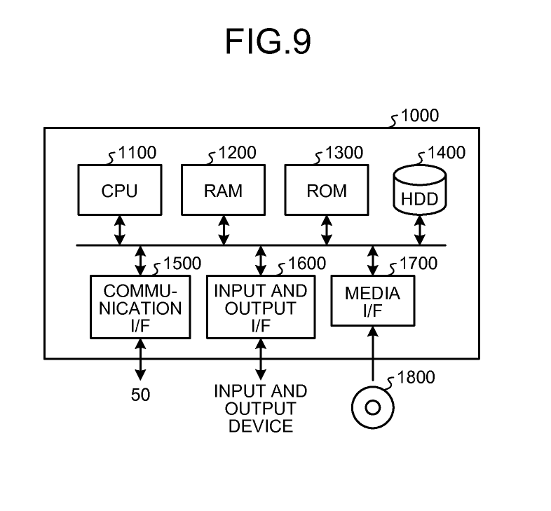

The response generation device 100 according to each of the embodiments is implemented, for example, with a computer 1000 having the configuration illustrated in FIG. 9. Hereinafter, the response generation device 100 will be described as an example. FIG. 9 is a diagram of the hardware configuration describing an exemplary computer 1000 that implements the functions of the response generation device 100. The computer 1000 includes a CPU 1100, a RAM 1200, a ROM 1300, an HDD 1400, a communication interface (I/F) 1500, an input and output interface (I/F) 1600, and a media interface (I/F) 1700.

The CPU 1100 operates in accordance with the program stored in the ROM 1300 or the HDD 1400 to control each unit. The ROM 1300 stores, for example, a boot program executed by the CPU 1100 when the computer 1000 starts, and a program depending on the hardware of the computer 1000.

The HDD 1400 stores, for example, a program executed by the CPU 1100, and the data used by the program. The communication interface 1500 receives the data from another device and transmits the data to the CPU 1100 through a communication network 50, and transmits the data generated by the CPU 1100 through the communication network 50 to another device.

The CPU 1100 controls an output device such as a display or a printer and an input device such as a keyboard or a mouse through the input and output interface 1600. The CPU 1100 obtains the data from the input device through the input and output interface 1600. The CPU 1100 outputs the generated data to the output device through the input and output interface 1600.

The media interface 1700 reads the program or data stored in a recording medium 1800, and provides the program or data stored to the CPU 1100 through the RAM 1200. The CPU 1100 loads the program from the recording medium 1800 to the RAM 1200 through the media interface 1700, and executes the loaded program. The recording medium 1800 is, for example, an optical recording medium such as a Digital Versatile Disc (DVD), or a Phase change rewritable Disk (PD), a magneto-optical recording medium such as a Magneto-Optical disk (MO), a tape medium, a magnetic recording medium, or a semiconductor memory.

For example, when the computer 1000 functions as the response generation device 100 according to the embodiment, the CPU 1100 in the computer 1000 implements the function of the control unit 130 by executing the program loaded on the RAM 1200. The data in the determination information storage unit 120 is stored in the HDD 1400. The CPU 1100 in the computer 1000 reads the programs from the recording medium 1800 and executes the programs. However, the CPU 1100 can obtain the program from another device through the communication network 50 as another example.

5-13. Others

All or some of the processes automatically performed among the processes described in the embodiments can manually be performed. All or some of the processes manually performed among the processes described in the embodiments can automatically be performed in a publicly known method. Additionally, the processes, specific names, information including various types of data and parameters that have been described herein or illustrated in the appended drawings can arbitrarily be changed if not otherwise specified.

Each of the components of each of the devices is functionally and conceptually illustrated, and thus does not have to be configured physically as illustrated in the drawings. In other words, a specific embodiment in which the devices are separated or integrated is not limited to the configurations illustrated in the drawings, and thus all or some of the devices can functionally or physically be separated or integrated in an arbitrary unit in response to various loads or usage conditions.

Furthermore, the embodiments can appropriately be combined without the conflict between the contents of the processes.

6. Effect

As described above, the response generation device 100 according to the embodiment includes the determination unit 132, and the output control unit 134. The determination unit 132 determines the trend in progress of the user interaction between the interactive agent system and the user. The output control unit 134 controls the output so as to output a response message in accordance with the trend in progress of the user interaction determined by the determination unit 132.

Accordingly, the response generation device 100 according to the embodiment can search for a response message appropriate to the user's characteristic and control the output. This can increase the user's satisfaction level with the user interaction. For example, the response generation device 100 can control the output of the response message along the context of the user interaction such that the topic is not changed when the user does not like a small talk. On the other hand, the response generation device 100 can improve the quality of the user interaction by controlling the output of the response message deviating from the context of the user interaction on purpose when the user likes a small talk.

The search unit 133 according to the embodiment searches the scope of search in accordance with the trend in progress of the user interaction determined by the determination unit 132 for the advertisement information to be output as the response message.

This search enables the response generation device 100 according to the embodiment to find a response message appropriate to the user's characteristic.

Furthermore, when the determination unit 132 determines that there is a trend that the topic is easily changed in the user interaction with the user, the search unit 133 according to the embodiment expands the scope of the search for the advertisement information in comparison with when the determination unit 132 determines that there is a trend that the topic is not easily changed in the user interaction with the user.

This extension enables the response generation device 100 to increase the user's satisfaction level with the user interaction. For example, the response generation device 100 can control the output so as to output a response message along the context of the user interaction to the user does not easily change the topic and does not like a small talk. Meanwhile the response generation device 100 can control the output so as to output a response message deviating from the context of the user interaction on purpose to the user who easily changes the topic and likes a small talk, and thus can increase the quality of user interaction.

When the determination unit 132 determines there is a trend that the topic is easily changed in the user interaction with the user, the search unit 133 according to the embodiment includes the advertisement information of which message is longer than a predetermined value in the scope of the search for the advertisement information.

This enables the response generation device 100 according to the embodiment to increase the user's satisfaction level with the user interaction. In other words, the user who easily changes the topic can be deemed as a person who likes a small talk. Thus, the response generation device 100 can increase the quality of the user interaction or excite the user interaction by controlling the output so as to output the advertisement information of which message is longer than a predetermined value on purpose. Consequently, the response generation device 100 can increase the satisfaction level of the user who likes a small talk.

When the determination unit 132 determines that there is a trend that the topic is not easily changed in the user interaction with the user, the search unit 133 according to the embodiment excludes the advertisement information of which message is longer than a predetermined value from the scope of the search for the advertisement information.

This enables the response generation device 100 according to the embodiment to increase the user's satisfaction level with the user interaction. In other words, the user who does not easily change the topic can be deemed as a person who does not like a small talk. The response generation device 100 does not control the output to output the advertisement information of which message is longer than a predetermined value, and thus can avoid giving an uncomfortable feeling to the user.

The output control unit 134 according to the embodiment outputs the response message selected in accordance with the determination information in which a node related to a predetermined input message is linked to a node related to a predetermined response message. The determination unit 132 determines the trend in progress of the user interaction with the user in accordance with the course of using nodes in the user interaction with the user.

This enables the response generation device 100 according to the embodiment to determine the user's characteristic only from the flow of the user interaction without grasping the contents of the user interaction.

The determination unit 132 according to the embodiment determines the trend in progress of the user interaction with the user based on the number of times that each node is used in the user interaction with the user.

This enables the response generation device 100 according to the embodiment to determine the trend in progress of the user interaction. Consequently, the response generation device 100 can determine the user's characteristic corresponding to the trend in progress of the user interaction.

When the number of times that any one of the nodes is used exceeds a predetermined value, the determination unit 132 according to the embodiment determines that the topic is easily changed in the user interaction with the user.

This enables the response generation device 100 according to the embodiment to determine the trend in progress of the user interaction. Consequently, the response generation device 100 determines the user's characteristic corresponding to the trend in progress of the user interaction.

Alternatively, the determination unit 132 according to the embodiment determines the trend in progress of the user interaction based on the total number of nodes used in the user interaction.

This enables the response generation device 100 according to the embodiment to determine the trend in progress of the user interaction. Consequently, the response generation device 100 can determine the user's characteristic corresponding to the trend in progress of the user interaction.

Alternatively, the determination unit 132 according to the embodiment determines the characteristic of the progress of the user interaction in accordance with the period of time from the time when the output control unit 134 outputs a response message to the time when a new input message is received from the user.

This enables the response generation device 100 according to the embodiment to determine the trend in progress of the user interaction. Consequently, the response generation device 100 can determine the user's characteristic corresponding to the trend in progress of the user interaction.

The determination unit 132 according to the embodiment determines the trend in progress of the user interaction with the user based on the required time to complete the user interaction with the user.

This enables the response generation device 100 according to the embodiment to determine the trend in progress of the user interaction. Consequently, the response generation device 100 can determine the user's characteristic corresponding to the trend in progress of the user interaction.

Some of the embodiments of the present invention have been described above with reference to the appended drawings. However, the embodiments are examples. In addition to the embodiments described in the column “SUMMARY OF THE INVENTION”, another embodiment variously changed or modified based on the knowledge of a person having ordinary skill in the art can implement the present invention.

The “unit” described above can be replaced with “system” or “circuits”. For example, the determination unit can be replaced with a specifying system or specifying circuit.

An aspect of the embodiments has the effect of outputting a message appropriate for the user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A response generation device comprising:
a determination unit that determines a trend in progress of user interaction between an interactive agent system and a user; and
an output control unit that controls output so as to output a response message in accordance with the trend in progress of the user interaction determined by the determination unit.

2. The response generation device according to claim 1, further comprising:
a search unit that searches a scope of a search for advertisement information to be output as a response message, the scope being in accordance with the trend in progress of the user interaction determined by the determination unit.

3. The response generation device according to claim 2, wherein, when the determination unit determines that there is a trend that a topic is easily changed in the user interaction with the user, the search unit expands the scope of the search for the advertisement information in comparison to when the determination unit determines that there is a trend that a topic is not easily changed in the user interaction with the user.

4. The response generation device according to claim 2, when the determination unit determines that there is a trend that a topic is easily changed in the user interaction with the user, the search unit includes advertisement information of which message is longer than a predetermined value in the scope of the search for the advertisement information.

5. The response generation device according to claim 2, wherein, when the determination unit determines that there is a trend that a topic is not easily changed in the user interaction with the user, the search unit excludes advertisement information of which message is longer than a predetermined value from the scope of the search for the advertisement information.

6. The response generation device according to claim 1, wherein the output control unit outputs a response message selected based on determination information in which a node related to a predetermined input message is linked to a node related to a predetermined response message, and
the determination unit determines the trend in progress of the user interaction with the user in accordance with a course of using nodes in the user interaction.

7. The response generation device according to claim 6, wherein the determination unit determines the trend in progress of the user interaction with the user based on the number of times that each node is used in the user interaction with the user.

8. The response generation device according to claim 7, wherein the determination unit determines that there is a trend that a topic is easily changed in the user interaction with the user when the number of times that any one of the nodes is used exceeds a predetermined value.

9. The response generation device according to claim 6, wherein the determination unit determines the trend in progress of the user interaction with the user based on the total number of the nodes used in the user interaction with the user.

10. The response generation device according to claim 1, wherein the determination unit determines a characteristic of progress of the user interaction with the user based on a period of time from a time when the output control unit outputs a response message to a time when a new input message is received from the user.

11. The response generation device according to claim 1, wherein the determination unit determines the trend in progress of the user interaction with the user based on a time required to complete the user interaction with the user.

12. A response generation method performed by a computer, the method comprising:
determining a trend in progress of user interaction between an interactive agent system and a user, the interactive agent system outputting a response message to an input message; and
controlling output so as to output a response message in accordance with the trend in progress of the user interaction determined in the determining step (a).

13. A non-transitory computer readable storage medium having stored therein a response generation program causing a computer to perform:
determining a trend in progress of user interaction between an interactive agent system and a user, the interactive agent system outputting a response message to an input message; and
controlling output so as to output a response message in accordance with the trend in progress of the user interaction determined in the determining step (a).
